(19) United States
(12) Patent Application Publication
(10) Pub. No.: US 2006/0149630 A1
(43) Pub. Date: Jul. 6, 2006

(54) Opt-in delivery of advertisements on mobile devices

(76) Inventors: Joseph Francis Elliott, San Francisco, CA (US); Fabrice Armisen, Berkeley, CA (US); Daniel Paul Raynaud, South San Francisco, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/281,942

(22) Filed: Nov. 16, 2005

Related U.S. Application Data
(60) Provisional application No. 60/628,857, filed on Nov. 16, 2004.

(51) Int. Cl. G06Q 30/00

(52) U.S. Cl. 705/14

(57) ABSTRACT

Advertisements provided to a mobile device user allow the user to obtain information from advertisers without revealing the user's identity. Advertisers supply advertisements to an advertising intermediary, which maintains the advertisements in a database, and also maintains a database of mobile device users who are subscribers to its service. Separately, application providers provide mobile applications to an application distributor. The application distributor in turn provides the applications to the mobile subscriber. The application distributor integrates advertisements supplied by the advertising intermediary into the applications and application content it distributes to the subscriber. If the subscriber requests additional information, an indication of this interest is sent to the advertising intermediary, which forwards additional information provided by the advertiser, such as a URL, product brochure, or the like to the mobile subscriber via his indicated preferred medium, e.g., e-mail or post, maintaining anonymity for the subscriber with respect to the advertisers.

### CROSS-REFERENCE TO RELATED APPLICATIONS

This application claims the benefit of U.S. Provisional Application No. 60/628,857, filed on Nov. 16, 2004, which is incorporated by reference herein in its entirety.

### BACKGROUND OF THE INVENTION

1. Field of the Invention

The present invention relates generally to delivery of advertisements on mobile devices such as cellular telephones.

2. Description of Background Art

Advertisers have recently begun targeting mobile devices such as cellular telephones and cellular-equipped PDAs as a channel for providing information to consumers about products and services. However, it has been difficult to provide the consumer with a convenient and safe channel to execute purchases of the products being advertised. Because mobile devices tend to have small display screens, and because fast network connections are not yet mainstream, the delivery of advertisements to mobile devices over cellular telephone networks is limited to text and simple graphics and sound. While this is somewhat useful to advertisers, it is cumbersome for mobile phone users who might want more information about a product or service before purchasing it than can be efficiently obtained through the provided advertisement. In addition, mobile devices typically have only a single user interface window available at any one time, and consequently even for mobile devices equipped with browsers, following a link to an advertisement takes the user of the device away from whatever activity he was originally intending to complete.

Many advertisements on mobile devices include a link or other option for the mobile device user to communicate directly with the advertiser. For example, in some cases the mobile device user can choose to initiate a telephone call to the advertiser directly from the advertisement. In other cases, the user can make a selection that transmits the user's contact information to the advertiser, allowing the advertiser to contact the user to follow up.

A significant drawback to these approaches is that they destroy the anonymity of the mobile device user by providing identifying information about the user to the advertiser. For many users, such a drawback is so undesirable that they will avoid responding to the advertisement and, consequently, the advertiser has lost a potential sale and the user has lost a potential purchase.

Accordingly, there is a need in the art for a convenient way to allow potential customers to respond to advertisements provided on a mobile device while maintaining anonymity.

### SUMMARY OF THE INVENTION

In accordance with the present invention, advertisements are provided to a mobile device user in such a way as to allow the user to obtain further information from advertisers without revealing the user's identity to the advertisers and without significantly detracting from the user's mobile device experience. In one embodiment of the present invention, advertisers supply advertisements to an advertising intermediary. The advertising intermediary maintains the advertisements in a database, and also maintains a database of mobile device users who are subscribers to its service. Separately, application providers provide mobile applications to an application distributor. In one embodiment, the applications include hooks for displaying advertisements. The application distributor may provide tools or libraries to the application provider to enable insertion of these hooks. The application distributor in turn provides the applications to the mobile subscriber, either as preloaded applications supplied with the mobile device, or on request, e.g., via download. The application distributor integrates advertisements supplied by the advertising intermediary into the applications and application content it distributes to the mobile subscriber. Advertisements are integrated into applications in various forms, for example as impressions, sponsorship screens, or surveys. As the mobile subscriber interacts with an application, he is presented with advertisements and provided with an opportunity to indicate an interest in receiving further information related to the advertised product or service. If the subscriber indicates an interest in receiving additional information, e.g., by selecting a link provided as part of the advertisement, an indication of this interest is sent to the advertising intermediary. The advertising intermediary in one embodiment includes preference information about the subscriber's preferred medium by which to receive additional information, e.g., via e-mail, postal mail, etc. The advertising intermediary then forwards additional information provided by the advertiser, such as a URL, product brochure, or the like to the mobile subscriber via his indicated preferred medium. The subscriber can then browse the advertiser's web site, view the advertiser's brochure or otherwise review information about the advertised product or service without the advertiser ever needing to obtain the subscriber's name or contact information. In such a manner, the subscriber maintains anonymity while still having access to the advertiser's information through a medium other than the mobile user's device.

### BRIEF DESCRIPTION OF THE DRAWINGS

FIG. 1 is a block diagram of the overall architecture of an embodiment of the present invention.

FIG. 2 is a block diagram of an advertising intermediary in accordance with an embodiment of the present invention.

FIG. 3 is an interaction diagram illustrating a method in accordance with an embodiment of the present invention.

### DETAILED DESCRIPTION OF THE PREFERRED EMBODIMENTS

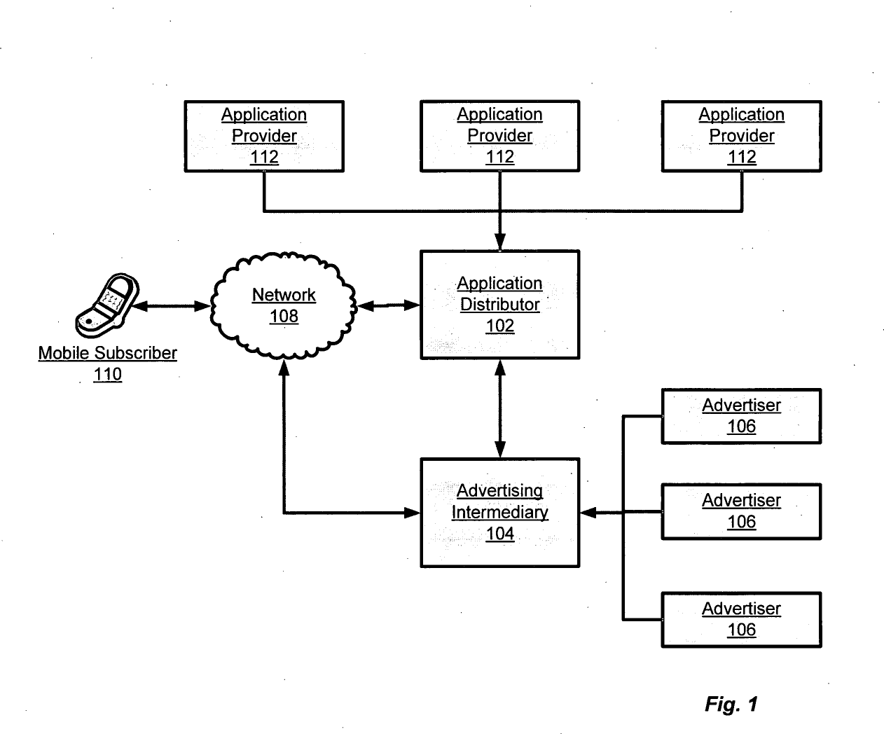

FIG. 1 illustrates a block diagram of a system in accordance with an embodiment of the present invention. FIG. 1 includes a plurality of advertisers 106, each of which provides advertisements to advertising intermediary 104. Advertising intermediary 104 in turn provides the advertisements to an application distributor 102. Application distributor 102 also receives mobile applications from a plurality of application providers 112. Application distributor 102 in turn distributes both applications and advertisements over a network 108 to a mobile device 110. Each item illustrated in FIG. 1 is now described in further detail.

An advertiser 106 prepares advertisements that it would like to deliver to users of mobile device 110. While FIG. 1 includes three such advertisers for purposes of illustration, any number of advertisers may participate. In one embodiment, advertiser 106 provides advertisements that appear on all or part of a display screen of a subscriber's mobile device 110. These advertisements could appear, for example, when a user attempts to make a call, perform an online service, or when the device is idle. In another embodiment, advertisements are designed to appear as sponsorship messages in conjunction with the use of mobile applications. For example, an advertiser may be interested in sponsoring a video game played using the mobile device. Sponsorship messages typically involve providing an advertisement on the mobile applications splash screen, and may also include having the advertiser's logo or slogan on some or all of the pages of the mobile application. Advertisements may include text, graphics, video and sound, in various combinations. In one embodiment, advertisements invite interaction with the subscriber, for example answering a question, giving a rating, choosing whether or not to receive more information, or a series of such interactions, for example in the form of a survey. Advertisements may also be displayed at periodic intervals when the mobile application is being used—for example, every 15 minutes, every third time the application is launched, or every time the subscriber enters a particular part of the application. Note also that the advertiser 106 could also be the provider of the application, the manufacturer of the mobile device, or even the network provider, such as a cellular telephone provider in the case of a cellular network.

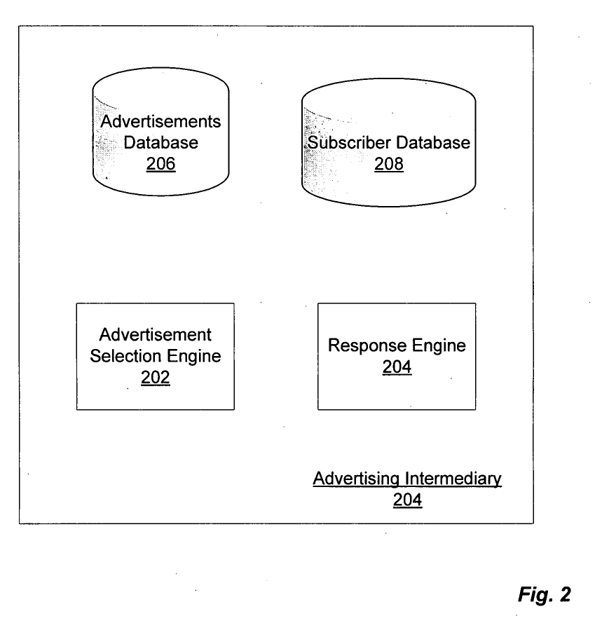

Advertisers 106 provide their advertisements to advertising intermediary 104. Advertising intermediary 104 is illustrated in greater detail in FIG. 2, and includes an advertisement selection engine 202, a response engine 204, an advertisement database 206, and a subscriber database 208. Advertisements received from advertisers are stored in advertisement database 206, along with an indication of the type of advertisement it is—e.g., a sponsorship screen, in-application impression, in-application survey, etc. In one embodiment, targeting information is also supplied with the advertisements and stored in advertisement database 206. Targeting information is information supplied by the advertiser 106 specifying its preference for which demographic should receive each advertisement.

Subscriber database 208 includes account information for each mobile phone service subscriber 110 that subscribes to the services offered by advertising intermediary 104. Account information in one embodiment includes an e-mail address, physical address or telephone number for the user's device, the user's name, and other contact information. In one embodiment the account information also includes demographic information about the subscriber which may be obtained, for example, via an interface through which the subscriber can provide the information along with preferences about the kinds of advertisements the subscriber wishes to receive. Subscriber database 208 in one embodiment also includes historical information about advertisements to which the mobile subscriber 110 has previously responded.

Advertisement selection engine 202 in one embodiment matches advertisements in advertisement database 206 with subscriber information in subscriber database 208, choosing the most desirable advertisements to show to each subscriber based both on the advertiser's specified target demographic for the advertisement and on the subscriber's indicated preferences for advertisements. In one embodiment, advertisements are selected for a subscriber based in part on advertisements to which the subscriber has previously responded. For example, if the subscriber has previously indicated an interest in a portable music player, future advertisements may be geared towards accessories for portable music players. In another embodiment the previous responses of the subscriber are compared with responses of other subscribers to select advertising content which is more likely to be of interest to the subscriber. Those of skill in the art will recognize that varying types of business and decision logic may be used to select the advertisement to provide to the user, employing techniques such as Bayesian Networks to determine which is the most appropriate advertisement to provide. Using predictive matching makes it more likely that subscribers are shown advertisements they are interested in, thus increasing the value both for them and the advertiser. Each advertisement preferably includes a response option by which the mobile phone service subscriber can reply to an advertisement that piques his interest. In one embodiment, the response option is a link or a form field displayed as part of the advertisement in a mobile web (e.g. WAP) browser. In another embodiment there is a user interface provided in a binary application allowing user interaction, and the application provides that response to the advertising intermediary 106 over the mobile network 108 using an appropriate encoding and communication protocol, e.g. TCP/IP or HTTP.

Application distributor 102 distributes mobile applications provided by application providers 112 to mobile subscribers 110, i.e. mobile device users that subscribe to the service offered by application distributor 102. Many types of mobile applications exist, including games, shopping applications, social networking applications, mapping applications, etc. Applications may be provided as downloaded or preinstalled binary applications, or as mobile web application that operate in conjunction with a mobile web browser. In one embodiment, application distributor 102 provides a portion of its advertising revenue to an application provider 112 in exchange for the application provider 112 allowing application distributor 102 to distribute its product. The advertising revenue may be a replacement for or used in conjunction with customer billing options, for example credit card, online payment service, or integration with billing services provided by mobile network carriers. Application distributor 102 may arrange with a mobile network provider or equipment manufacturer to have mobile devices shipped with mobile applications preinstalled, or alternatively provides a subscriber 110 to its service with an opportunity to download the application, e.g., over the mobile network 108. Advertising content is typically provided over the network 108 after the application is installed on the mobile device, however in the alternative some or all advertising content can also be pre-built into the application. Application distributor 102 may send advertisements piggybacked on application content it provides as part of its runtime service, for example if the application distributor provides player matching service to a multiplayer game. In one embodiment, application distributor 102 requests an advertisement from the advertising intermediary 104, specifying a type of advertisement, e.g., a sponsorship splash screen shown when starting the application, application sponsorship logos embedded within other application screens, non-interactive advertising messages (commonly called ‘Impressions’), advertising messages or surveys requiring interaction from the user, etc. In one embodiment, the application distributor 102 additionally specifies the application in which the advertisement is being inserted as well as the subscriber who will receive the advertisement. This allows advertisement selection engine 202 to select an advertisement appropriate for the subscriber, or for a combination of subscriber and application.

Note that the application providers 112, application distributor 102 and advertising intermediary 104 are shown as separate entities in FIG. 1 in order to illustrate the logical organization of one embodiment of the present invention. In implementation, a variety of relationships are possible—for example, application distributor 102 may be a separate business entity from advertising intermediary 104, which itself contracts with advertisers 106. Alternatively, application distributor 102 may be the same business entity as advertising intermediary 104, and thereby contract directly with advertisers 106, and may be the same business entity as application provider 112. Still further, advertisers 106 may be single business entities, or advertising agencies that represent advertisers.

Application distributor 102 communicates with mobile subscriber 110 via a network 108. In a preferred embodiment, network 108 is a cellular network, though other networks, such as a wireless internet network (for example a WiFi mesh or WiMax service), can be used if they support mobile devices. Mobile subscriber 110 receives data from application distributor 102, and the received data including the received advertisement is displayed on the mobile subscriber's device.

As described above, the displayed advertisement preferably includes a response mechanism by which the mobile subscriber 110 can indicate his interest in obtaining further information anonymously from the advertiser. By triggering the response mechanism, a message is sent from the mobile subscriber's device over the network 108 to the response engine 204 of advertising intermediary 104. In one embodiment, the message includes information to identify the subscriber, such as the subscriber's telephone number or subscriber ID; the advertisement being responded to; the application associated with the advertisement; and the time at which the response was made. As will be appreciated by those of skill in the art, more or fewer data elements could be transmitted, so long as enough information is sent to allow response engine 204 to identify the advertisement being responded to and the subscriber responding to it.

In order to minimize inconvenience to the mobile subscriber 110, in one embodiment advertisements are downloaded to the mobile device and responses are sent from the mobile device when the device has already established a data connection with the network for other reasons. This piggybacking technique minimizes interruption to the user by eliminating the requirement to establish a new connection with the network. Moreover, advertising data and response data can be aggregated together to minimize the number of connections with the network and thereby reduce the cost and inconvenience to the user associated with those connections. In an alternative embodiment, data is transmitted at a specific time each day, for example at 2:00 AM, when the mobile device is unlikely to be in use. In yet another embodiment, the device transfers data when it has been idle for longer than a threshold amount of time, e.g, an hour.

Upon receiving the message back from the mobile subscriber 110, response engine 204 determines based on information provided by the advertiser what additional information should be sent to the mobile subscriber 110. For example, in one embodiment the advertiser specifies a URL to be sent to the mobile subscriber. In another embodiment, the advertiser specifies that a brochure should be mailed to the mobile subscriber through the postal service. The mobile subscriber in one embodiment specifies how often he would like to receive e-mail with links to product information—for example, he may specify that he prefers to receive only a weekly e-mail, with information about all of the advertisements he has shown an interest in over the course of the week. Alternatively, he may prefer to receive an e-mail immediately each time he indicates an interest. In one embodiment, prior to providing the additional information to the mobile subscriber, response engine 204 determines from data in the subscriber database 208 whether the subscriber has previously indicated a willingness to receiving information via a particular contact method. For example, the subscriber may have indicated that he is willing to accept e-mail but not postal mail. In such a case, response engine 204 will send a URL to the advertiser's product page to the subscriber via e-mail, but will not mail a brochure to the subscriber via postal mail. In one embodiment, the subscriber can specify as part of his response which delivery method he prefers. Because the information is forwarded to the mobile subscriber 110 by advertising intermediary 104, and not by the advertiser 106, at no time does advertiser 106 become aware of the mobile subscriber's identity 110, unless the mobile subscriber chooses to contact the advertiser 106 directly. Thus, the user can receive product information by e-mail or postal mail directly from the advertising intermediary 104 and maintain his anonymity with respect to the advertiser.

In the case of sending a URL by e-mail, in one embodiment the link provided by advertising intermediary 104 links to the advertiser 106 via the advertising intermediary's server. This allows advertising intermediary 104 to track the response rate based on e-mails sent to mobile subscribers, which can be used, for example, to adjust the amount charged to a particular advertiser 106. In addition, it allows advertising intermediary 104 to take action based on the failure of a user to follow the URL provided by an e-mail. For example, advertising intermediary 104 could send a follow-up e-mail to the mobile subscriber 110 after two days, reminding him that he has not visited the URL and providing it again.

In one alternative embodiment, in the case of a sponsorship advertisement, when a mobile subscriber 110 initially installs or activates an application provided by application distributor 102, an e-mail or postal mail message is sent to the subscriber, for example as a thank you message, and including additional information about the sponsor.

In another embodiment, the mobile subscriber 110 is asked on occasion by the application associated with application distributor 102 whether the subscriber is willing to take a survey or otherwise provide feedback about a particular topic. If the subscriber responds in the affirmative, the survey or additional request is forwarded to the subscriber via postal or e-mail.

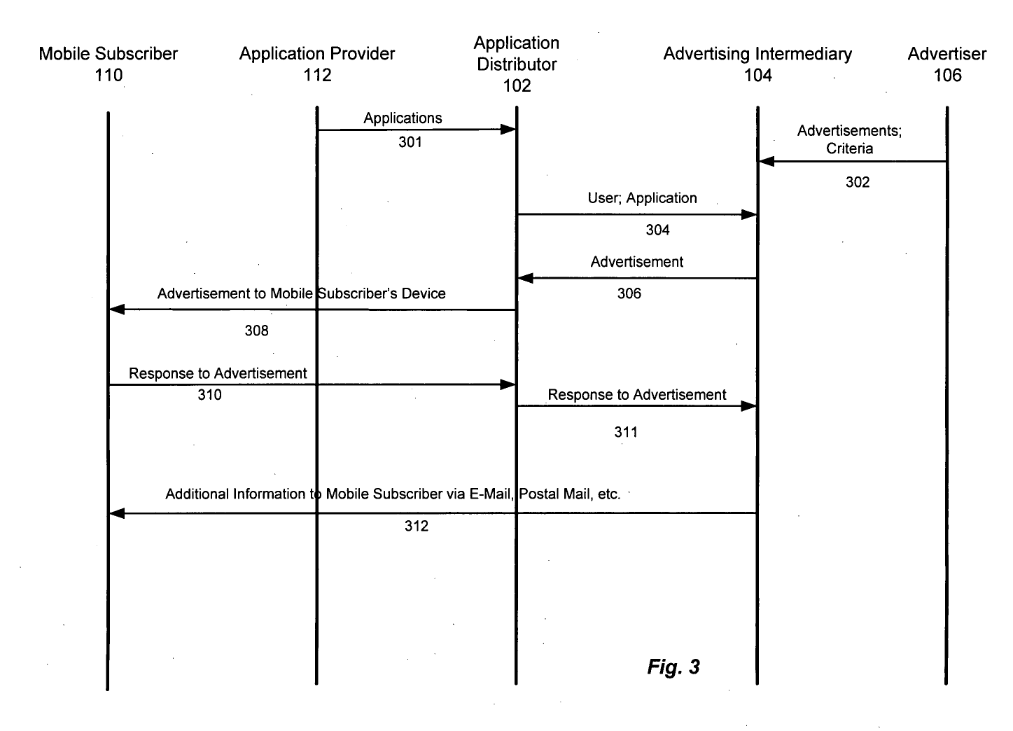

Referring now to FIG. 3, there is shown an interaction diagram illustrating a method as described above in an embodiment of the present invention. An application provider 112 provides 301 applications to application distributor 102, and an advertiser 106 provides 302 advertisements and targeting data to advertising intermediary 104. When an application requests an advertisement from application distributor 102, application distributor 102 transmits 304 data to advertising intermediary 104 about which subscriber is using which application. Note that in an alternative embodiment, an application requests an advertisement directly from advertising intermediary 104. In response to the request for an advertisement, advertisement selection engine 202 of advertisement intermediary 104 selects an appropriate advertisement and transmits 306 the selected advertisement back to application distributor 102. Application distributor 102 then forwards 308 the advertisement to the mobile subscriber 110.

If mobile subscriber 110 responds to the advertisement, the response is forwarded 310 through the network 108 to application distributor 102 and subsequently 311 to advertising intermediary 104, which then obtains and sends 312 additional information to the mobile user 110 at the mobile user's specified e-mail or postal mail address. Note that in an alternative embodiment, the response is forwarded directly to advertising intermediary 104 instead of via application distributor 102.

Note that in other embodiments, the present invention has application beyond the domain of advertisements. Any third-party content can be provided to mobile subscribers 110, providing the subscribers with an opportunity respond to an intermediary and obtain additional information directly from the intermediary without identifying the subscriber to the third-party content provider.

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. For example, the particular functions of the application distributor 102, advertising intermediary 104, and so forth may be provided in many or one module.

Some portions of the above description present the feature of the present invention in terms of algorithms and symbolic representations of operations on information. These algorithmic descriptions and representations are the means used by those skilled in the mobile advertising arts to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality. It should be borne in mind, however, that all of these and similar terms are to be associated with the appropriate physical quantities and are merely convenient labels applied to these quantities.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any references to specific languages are provided for disclosure of enablement and best mode of the present invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

We claim:

1. A method for providing advertisements on a mobile device, the method comprising:
receiving, by an advertising intermediary, an advertisement from an advertiser;
providing the advertisement by the advertising intermediary to a mobile device;
receiving at the advertising intermediary from the mobile device a request for additional information related to the advertisement; and
providing by the advertising intermediary additional information related to the advertisement in response to the request without identifying the mobile device to the advertiser.

2. The method of claim 1 wherein the additional information is provided via electronic mail.

3. The method of claim 1 wherein the additional information is provided via postal mail.

4. A system for providing advertisements on a mobile device, the system comprising:
an advertising intermediary for:
receiving an advertisement from an advertiser;
providing the advertisement to an application distributor;
receiving from a mobile device a request for additional information about the advertisement;
providing additional information related to the advertisement in response to the request without identifying the mobile device to the advertiser;
an application distributor, communicatively coupled to the advertisement intermediary, for:
receiving a request from an application of the mobile device for an advertisement; and
providing to the mobile device the advertisement provided by the advertising intermediary

5. The system of claim 4 wherein the additional information is provided via electronic mail.

6. The system of claim 4 wherein the additional information is provided via postal mail.

7. A computer program product for providing advertisements on a mobile device, the computer program product stored on a computer-readable medium and including instructions configured to cause a processor of a computer to carry out the steps of:
receiving an advertisement from an advertiser;
providing the advertisement to a mobile device;
receiving from the mobile device a request for additional information related to the advertisement; and
providing additional information related to the advertisement in response to the request without identifying the mobile device to the advertiser.

8. The system of claim 7 wherein the additional information is provided via electronic mail.

9. The system of claim 7 wherein the additional information is provided via postal mail.
